(19) United States
(12) Patent Application Publication
(10) Pub. No.: US 2017/0013044 A1
(43) Pub. Date: Jan. 12, 2017

(54) SYSTEMS AND METHODS FOR DETECTING A PROXY

(71) Applicant: Limited Liability Company Mail.Ru, Moscow (RU)

(72) Inventor: Igor Nikolaevich GERVASIYCHUK, Odinzovo (RU)

(21) Appl. No.: 15/000,019

(22) Filed: Jan. 18, 2016

Related U.S. Application Data
(63) Continuation of application No. PCT/RU2013/000623, filed on Aug. 21, 2013.

(51) Int. Cl. H04L 29/08; H04L 29/12; G06F 17/30

(52) U.S. Cl. CPC H04L 67/06; G06F 17/30876; H04L 67/28; H04L 67/02; H04L 61/1511

(57) ABSTRACT

A computer-implemented method for detecting a proxy, the method being performed in connection with a networking system comprising a web server, a domain name system (DNS) server and a database system, the method comprising: receiving at the web server a request from a client; responsive to the received request, generating a file containing a domain name information and a file name information and storing the domain name information and the file name information in the database system and returning the generated script file to the client; receiving at the DNS server a DNS request, the DNS request specifying a second domain name information for a second domain name to be resolved; responsive to the received DNS request, storing a first origination IP address associated with received DNS request and the second domain name information in the database system; receiving at the web server a second request from a client, the second request specifying a second file name information; responsive to the received second request, storing a second origination IP address associated with received second request and the second file name information in the database system; and determining whether the second origination IP is the proxy based on information stored in the database system.

### BACKGROUND OF THE INVENTION

Field of the Invention

The disclosed embodiments relate in general to the field of networking technology and in particular to systems and methods for real-time network proxy detection.

Description of the Related Art

The most commonly used conventional advertising revenue model is pay-per-click model, which is well known to persons of ordinary skill in the art. Pursuant to this advertising model, advertisers pay the publisher based on the number of the users' clicks on their online advertisements as well as the price of search keywords associated with the advertisements. The higher is the keyword price and the number of user clicks, the greater is the amount the advertiser is charged for displaying the advertisement. Unfortunately, the pay-per-click advertising model is subject to manipulation by malicious users, which is called “click fraud.” Click fraud usually involves artificially creating a large number of advertisement clicks using an automated program or human users who have no intention of purchasing the advertised goods or services.

One of the click fraud models involves hiring a large number of individuals in an inexpensive geographical area to click on online advertisements served by an advertisement publisher with geo targeting set to a high-cost pay per click (PPC) area and associated with expensive search keywords, such as “mortgage”, “insurance”, “finance”, etc. To mislead the advertising network, a socks4 or socks5 network proxy can be used to hide the IP addresses of actual users from the advertiser and to instead substitute them with IP addresses appearing to be originating from geographical locations with high cost of PPC, such as Europe, United States or Canada. The advertising network then believes that the clicks were produced by legitimate target audience and charges advertiser for the fraudulent clicks.

The conventional method for combatting the described click fraud is to use statistical analysis of user behavior (an example of click fraud detection using statistical methods, U.S. Pat. No. 7,657,626 B1), with one of the signals that can be used for fraudulent click detection is to the use of the proxy, which is usually accomplished by watching the network traffic from a specific IP address for a predetermined, usually substantial, period of time. As would be appreciated by those of skill in the art, the method of blacklisting proxies when presented with a sufficient number of data points has limited efficiency as fraudsters are able to change proxies upon being detected.

Thus, new and improved systems and methods for network proxy detection are needed to effectively combat the click fraud.

### SUMMARY OF THE INVENTION

The inventive methodology is directed to methods and systems that substantially obviate one or more of the above and other problems associated with conventional techniques for network proxy detection.

In accordance with one aspect of the embodiments described herein, there is provided a computer-implemented method for detecting a proxy, the method being performed in connection with a networking system comprising a web server, a domain name system (DNS) server and a database system, the method involving: receiving at the web server a request from a client; responsive to the received request, generating a file containing a domain name information and a file name information and storing the domain name information and the file name information in the database system and returning the generated script file to the client; receiving a DNS request on the DNS server, the DNS request specifying a domain name specified in the file generated by the web server; responsive to the received DNS request, storing a first origination IP address associated with received DNS request and the domain name information in the database system; receiving at the web server a second request from a client, the second request with a file name information specified in a web server response to the request from the client; responsive to the received second request, storing a second origination IP address associated with received second request and the second file name information in the database system; and determining whether the second origination IP is the proxy based on information stored in the database system.

In one or more embodiments, the script file is a Java Script file.

In one or more embodiments, the domain name information and the file name information are both randomly generated.

In one or more embodiments, the determining whether the second origination IP is the proxy is based on comparing the stored domain name information and a file name information with the second domain name information and a second file name information.

In one or more embodiments, the determining whether the second origination IP is the proxy is based on a geographical distance between a first geographical location of the first origination IP address and a second geographical location of the second origination IP address.

In one or more embodiments, the determining whether the second origination IP is the proxy is based on a first country of the first origination IP address and a second country of the second origination IP address.

In one or more embodiments, the script file is configured to cause the client to issue a request for a unit of content specified by the domain name information and a file name information.

In accordance with another aspect of the embodiments described herein, there is provided a non-transitory computer-readable medium embodying a set of computer-readable instructions, which, when executed in connection with a networking system comprising a web server, a domain name system (DNS) server and a database system, cause the networking system to perform a method for detecting a proxy, the method involving: receiving at the web server a request from a client; responsive to the received request, generating a file containing a domain name information and a file name information and storing the domain name information and the file name information in the database system and returning the generated script file to the client; receiving a DNS request on the DNS server, the DNS request specifying a domain name specified in the file generated by the web server; responsive to the received DNS request, storing a first origination IP address associated with received DNS request and the domain name information in the database system; receiving at the web server a second request from a client, the second request with a file name information specified in the web server response (a); responsive to the received second request, storing a second origination IP address associated with received second request and the second file name information in the database system; and determining whether the second origination IP is the proxy based on information stored in the database system.

In one or more embodiments, the script file is a Java Script file.

In one or more embodiments, the domain name information and the file name information are both randomly generated.

In one or more embodiments, the determining whether the second origination IP is the proxy is based on comparing the stored domain name information and a file name information with the second domain name information and a second file name information.

In one or more embodiments, the determining whether the second origination IP is the proxy is based on a geographical distance between a first geographical location of the first origination IP address and a second geographical location of the second origination IP address.

In one or more embodiments, the determining whether the second origination IP is the proxy is based on a first country of the first origination IP address and a second country of the second origination IP address.

In one or more embodiments, the script file is configured to cause the client to issue a request for a unit of content specified by the domain name information and a file name information.

1. In accordance with yet another aspect of the embodiments described herein, there is provided a computerized system for detecting a proxy, the system incorporating: a database system; a web server for: receiving a request from a client; and responsive to the received request, generating a file containing a domain name information and a file name information and storing the domain name information and the file name information in the database system and returning the generated script file to the client; a domain name server (DNS) for: receiving a DNS request on the DNS server, the DNS request specifying a domain name information for a domain name to be resolved; and responsive to the received DNS request, storing a first origination IP address associated with received DNS request and the domain name information in the database system. In the computerized system, the web server receives a second request from a client, the second request specifying a file name information specified in the first response of the web server; responsive to the received second request, the web server stores a second origination IP address associated with the received second request and the second file name information in the database system; and the proxy is detected based on information stored in the database system.

In one or more embodiments, the script file is a Java Script file.

In one or more embodiments, the domain name information and the file name information are both randomly generated.

In one or more embodiments, the determining whether the second origination IP is the proxy is based on comparing the stored domain name information and a file name information with the second domain name information and a second file name information.

In one or more embodiments, the determining whether the second origination IP is the proxy is based on a geographical distance between a first geographical location of the first origination IP address and a second geographical location of the second origination IP address.

In one or more embodiments, the determining whether the second origination IP is the proxy is based on a first country of the first origination IP address and a second country of the second origination IP address.

In one or more embodiments, the script file is configured to cause the client to issue a request for a unit of content specified by the domain name information and a file name information.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computerized system for network proxy detection.

FIG. 2 illustrates an exemplary operating sequence of an embodiment of the computer-implemented method for proxy detection.

FIG. 3 is a block diagram that illustrates an embodiment of a computer system upon which an embodiment of the inventive functionality may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there is provided a computerized system and a computer-implemented method for network proxy detection and combating the click fraud. In one or more embodiments, the computerized system for network proxy detection incorporates an HTTP server, a Domain Name System (DNS) server and a database. The operation of the computerized system and a computer-implemented method for real-time network proxy detection and combating the click fraud will now be described in detail with reference to the attached drawings.

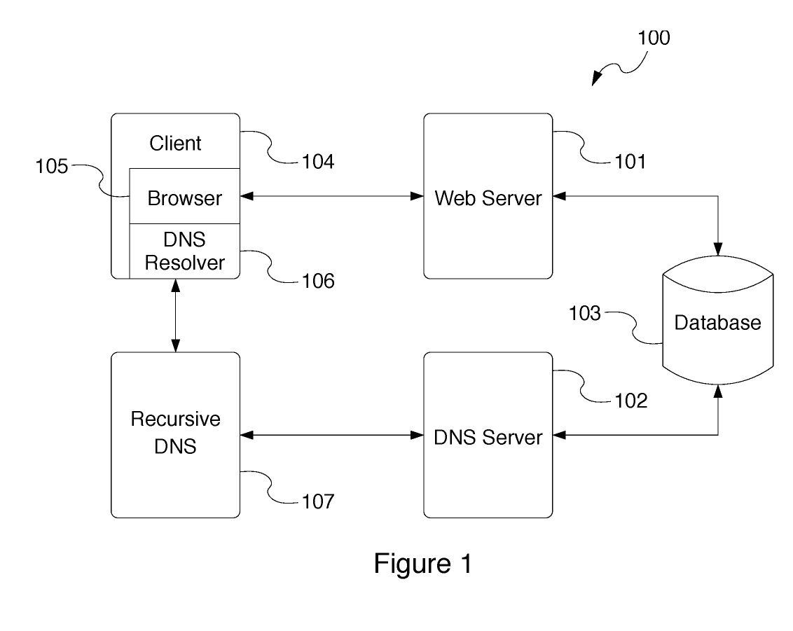

FIG. 1 illustrates an exemplary embodiment of a computerized system 100 for network proxy detection. The computerized system 100 incorporates a web (HTTP) server 101, a DNS server 102 and a database system 103. The web server 101 receives HTTP protocol requests from a client 104 executing browser 105 and, responsive to the received HTTP requests provides responses HTTP response containing HTML content, Java code, images as well as any other content capable of being transmitted over network. As would be appreciated by those of skill in the art, the design and implementation of the web server 101 is not critical to the present invention. Any now known or later developed type of the web server 101 may be utilized in implementing the web server 101. By way of example and not limitation, the web server 101 may be implemented using Apache web server, Microsoft Windows Server, Sun web server, Google web server, and/or Nginx web server, all of which are well known to persons of ordinary skill in the art, or any other suitable web server product. The client 104 additionally executes an OS DNS resolver 106. Also provided is a recursive DNS server 107 handling DNS requests from the client's DNS resolver 106.

In one or more embodiments, the web server 101 is configured to dynamically generate JavaScript code by inserting two random or pseudo-random values into a Java Script code template and to store the resulting generated code on a storage medium. In one or more embodiments, the aforesaid inserted values may be generated by applying a hash function to randomly generated number or not a random value, such as the internal time of the web server 101. In one or more embodiments, the aforesaid hash function may be, for example, MD5 or SHA, which are both well known to persons of ordinary skill in the art. In one or more embodiments, the generated values are alphanumeric character strings of a predetermined length, such as 24 symbols. The two dynamically generated values are stored in the database system 103.

In one or more embodiments, the dynamically generated Java script code is sent to the client 104 as a part of the response of the web server 101 to the client's HTTP request. In one or more embodiments, the aforesaid Java script code may be incorporated in HTML code sent to the client 104 in a manner well known to persons of ordinary skill in the art.

When the Java script code is received by the client 104, it is configured to cause the client 104 to download a token image from a web address also referred to as uniform resource locator or URL, which includes the two generated values. In one exemplary embodiment, the aforesaid image URL may be in the following format:

http://[first generated value].[domain name].[tld]/[file name/second generated value].[image file extension].

The [domain name] is the name of the domain used for proxy detection, while [tld] is a top level domain name such as .com or .net. An exemplary domain name is ig4.co. [Image file extension] is the extension of the downloaded image file, such as .gif or .jpg. The DNS server 102 is responsible for the domain used for the proxy detection, for example domain ig4.co.

In one or more embodiments, when the client 104 attempts to download the token image, the client first causes a DNS request to be sent to the DNS server 102, responsible for the domain hosting the token image, in order to resolve the IP address pointed by domain name in the image URL. In accordance with the DNS protocol, well known to persons of ordinary skill in the art, the DNS server 102 responsible for the domain hosting the token image receives the DNS request. Upon processing the received DNS request, the DNS server 102 responds back with the IP address of the web server 101 and causes two values to be stored in the database system 103. The first stored value is the origination address of the received DNS request sent via the UDP protocol well known to persons of ordinary skill in the art. The second stored value is the first portion of the URL of the token image file (before first “.”), which, in the described embodiment, is the first value dynamically generated by the server 101, as described above. As would be appreciated by those of skill in the art, this value corresponds to the host portion of the domain name of the token image URL.

After receiving the IP address of the web server 101, the client 104 sends HTTP request for the token image to the web server 101. Upon processing of the received HTTP request, the web server 101 sends back the requested token image and causes two additional values (third and fourth) to be stored in the database system 103. The third stored value is the IP address of the received HTTP request sent via TCP protocol, well known to persons of ordinary skill in the art. The fourth value stored in the database 103 is the token image file name, which is the second value dynamically generated by the server 101, as described above.

It should be noted that the database system 103 may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database system 103.

After completion of the last step, the database system 103 stores four received values for each processed client request: 1) token image file name (second generated value); 2) the host portion of the domain name (first generated value); (3) origination IP address of the received DNS request; and (4) origination IP address of the HTTP request as well as the two stored locally generated values including the first dynamically generated value and the second dynamically generated value, which correspond, respectively, to the token image file name (1) and the host portion of the domain name (2).

In one or more embodiments, subsequently, the two stored locally generated values are compared with the stored received values (1) and (2) corresponding to the same or different request. If there is no match between the above two pairs of values within a set of database records accumulated within one hour time frame, the algorithm flags the corresponding IP address as a the IP address of a suspected proxy. In one or more embodiments, the flagged IP address is subsequently blocked.

On the other hand, if the above two pairs match within a set of database records accumulated within one hour time frame, the system automatically determines the geographical coordinates of the origination IP address of the received DNS request; and the origination IP address of the HTTP request. In one or more embodiments the country information may also be obtained for both locations. After that, the geographical distance between the two determined locations is found. The aforesaid distance and, optionally, the country information is subsequently used in connection with an anomaly detection algorithm well known to persons of ordinary skill in the art. It should be noted that the anomaly detection algorithm may need to accumulate some statistics for purposes of calibrating the threshold value.

If the anomaly is detected, such as when the origination IP address of the DNS request is in a different country from the origination IP address of the HTTP request, the IP address associated with the HTTP request is flagged as a suspected proxy and may be blocked by the system. It should be noted that in one or more embodiments, the token image file may be replaced with another Java Script file, which may be configured to load asynchronously. This configuration may improve the web page loading times.

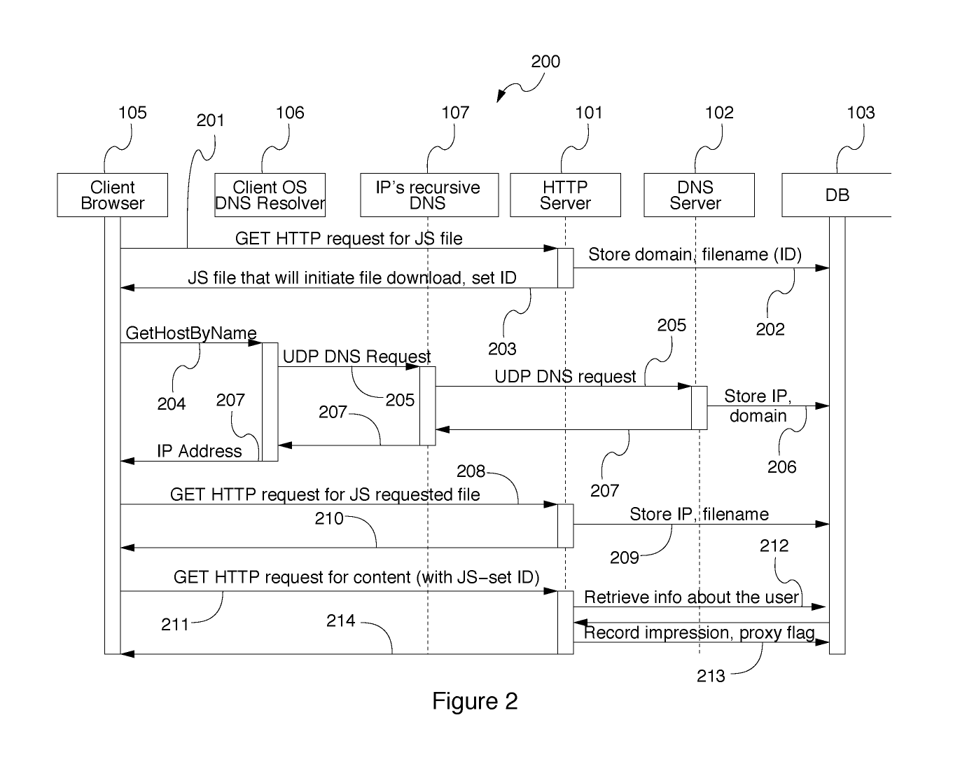

FIG. 2 illustrates an exemplary operating sequence 200 of an embodiment of the computer-implemented method for proxy detection. First, the client browser 105 sends HTTP GET request 201 for the Java script file to the HTTP server 101. In response, the web server 101 dynamically generates a Java script file containing a request for a token image with a random domain name information and a random file name information, which are subsequently used as identifiers. The generated domain and file name information 202 is stored in the database system 103 and the web server 101 returns the generated Java Script file 203 back to the client browser 105.

After receiving the Java Script file, the client browser 105 tries to resolve the domain name of the embedded token image file and sends request 204 to the client DNS resolver 106. In response, the DNS resolver 106 sends UDP DNS request 205 to the recursive DNS server 107, which, in turn, forwards this request to the DNS server 102. The DNS server 102 stores the request origin IP and the domain name to be resolved 206 in the database system 103 and responds with the IP address 207 of the web server 101, which is forwarded by the recursive DNS server 107 and DNS resolver 106 to the client browser 105.

After receiving the IP address of the server storing the image file, the client web browser 105 sends HTTP GET request 208 for the image file. Upon receiving this request, the web server 101 stores request origination IP address and the file name 209 in the database system 103. At this point, the database system 13 stores sufficient information for proxy detection and the anomaly detection algorithm described above may be used to detect possible proxies. The web server 101 responds with the token image 210.

In an alternative embodiment, the web browser 105 may send a request 211 containing an identifier set by the downloaded Java Script. In this embodiment, the web server 101, after receiving of the aforesaid request, retrieves information about the user 212 and records an impression and the proxy flag 213 to the database system 103. The requested token image is returned, see 214.

It should be noted that the embodiments described herein are not limited to using the token images. Any other type of content including, without limitation, Java Script, may be also used in connection with the described techniques. In addition, the same result may be achieved without the use of Java Script, thus the invention is not so limited.

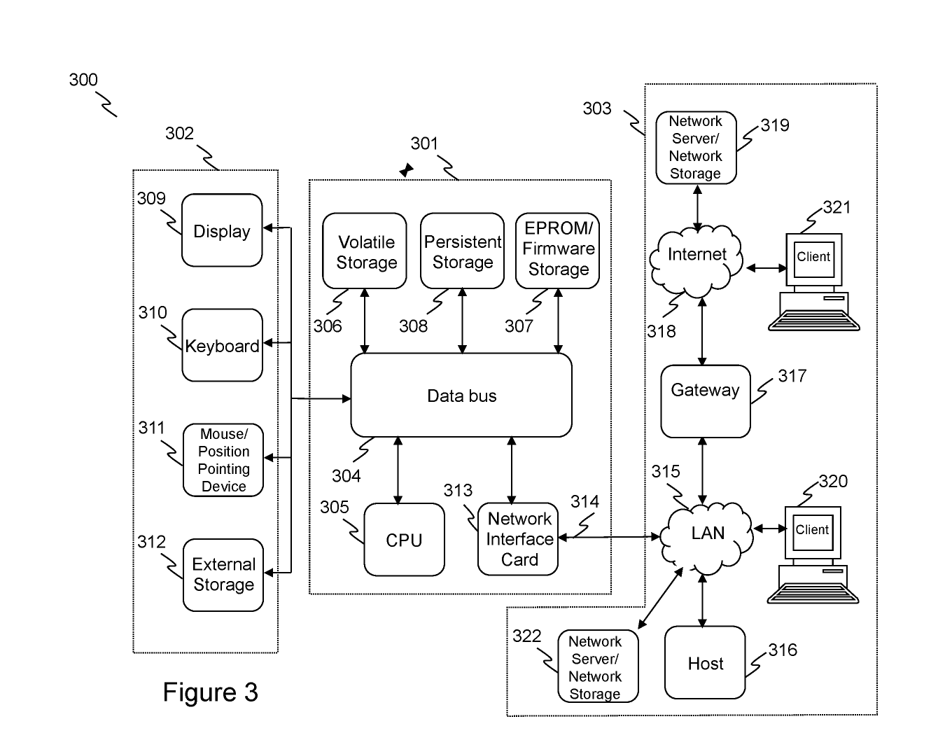

FIG. 3 is a block diagram that illustrates an embodiment of a computer system 300 upon which various embodiments of the inventive concepts described herein may be implemented. The system 300 includes a computer platform 301, peripheral devices 302 and network resources 303.

The computer platform 301 may include a data bus 304 or other communication mechanism for communicating information across and among various parts of the computer platform 301, and a processor 305 coupled with bus 304 for processing information and performing other computational and control tasks. Computer platform 301 also includes a volatile storage 306, such as a random access memory (RAM) or other dynamic storage device, coupled to bus 304 for storing various information as well as instructions to be executed by processor 305, including the software application for proxy detection described above. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 304 for storing information and instructions.

Computer platform 301 may be coupled via bus 304 to a touch-sensitive display 309, such as a cathode ray tube (CRT), plasma display, or a liquid crystal display (LCD), for displaying information to a system administrator or user of the computer platform 301. An input device 310, including alphanumeric and other keys, is coupled to bus 304 for communicating information and command selections to processor 305. Another type of user input device is cursor control device 311, such as a mouse, a trackball, or cursor direction keys for communicating direction information and command selections to processor 305 and for controlling cursor movement on touch-sensitive display 309. This input device typically has two degrees of freedom in two axes, a first axis (e.g., x) and a second axis (e.g., y), that allows the device to specify positions in a plane. To detect user's gestures, the display 309 may incorporate a touchscreen interface configured to detect user's tactile events and send information on the detected events to the processor 305 via the bus 304.

An external storage device 312 may be coupled to the computer platform 301 via bus 304 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 314 typically provides data communication through one or more networks to other network resources. For example, network link 314 may provide a connection through local network 315 to a host computer 316, or a network storage/server 322. Additionally or alternatively, the network link 314 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through the Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

The received code may be executed by Java Script interpreter on processor 505 as it is received, and/or stored in persistent or volatile storage devices 508 and 506, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for real-time network proxy detection and combating the click fraud. It is intended that the specification and examples be considered as exemplary only, with a true scope and spirit of the invention being indicated by the following claims.

What is claimed is:

2. A computer-implemented method for detecting a proxy, the method being performed in connection with a networking system comprising a web server, a domain name system (DNS) server and a database system, the method comprising:
a. receiving at the web server a request from a client;
b. responsive to the received request, generating a file containing a domain name information and a file name information and storing the domain name information and the file name information in the database system and returning the generated script file to the client;
c. receiving a DNS request on the DNS server, the DNS request specifying a domain name specified in the file generated by the web server;
d. responsive to the received DNS request, storing a first origination IP address associated with received DNS request and the domain name information in the database system;
e. receiving at the web server a second request from a client, the second request with a file name information specified in a web server response to the request from the client;
f. responsive to the received second request, storing a second origination IP address associated with received second request and the second file name information in the database system; and
g. determining whether the second origination IP is the proxy based on information stored in the database system.

3. The computer-implemented method of claim 1, wherein the script file is a Java script file.

4. The computer-implemented method of claim 1, wherein the domain name information and the file name information are both randomly generated.

5. The computer-implemented method of claim 4, wherein the determining whether the second origination IP is the proxy is based on comparing the stored domain name information and a file name information with the second domain name information and a second file name information.

6. The computer-implemented method of claim 1, wherein the determining whether the second origination IP is the proxy is based on a geographical distance between a first geographical location of the first origination IP address and a second geographical location of the second origination IP address.

7. The computer-implemented method of claim 1, wherein the determining whether the second origination IP is the proxy is based on a first country of the first origination IP address and a second country of the second origination IP address.

8. The computer-implemented method of claim 1, wherein the script file is configured to cause the client to issue a request for a unit of content specified by the domain name information and a file name information.

9. A non-transitory computer-readable medium embodying a set of computer-readable instructions, which, when executed in connection with a networking system comprising a web server, a domain name system (DNS) server and a database system, cause the networking system to perform a method for detecting a proxy, the method comprising:
a. receiving at the web server a request from a client;
b. responsive to the received request, generating a file containing a domain name information and a file name information and storing the domain name information and the file name information in the database system and returning the generated script file to the client;
c. receiving a DNS request on the DNS server, the DNS request specifying a domain name specified in the file generated by the web server;
d. responsive to the received DNS request, storing a first origination IP address associated with received DNS request and the domain name information in the database system;
e. receiving at the web server a second request from a client, the second request with a file name information specified in the web server response (a);
f. responsive to the received second request, storing a second origination IP address associated with received second request and the second file name information in the database system; and
g. determining whether the second origination IP is the proxy based on information stored in the database system.

10. The non-transitory computer-readable medium of claim 8, wherein the script file is a Java script file.

11. The non-transitory computer-readable medium of claim 8, wherein the domain name information and the file name information are both randomly generated.

12. The non-transitory computer-readable medium of claim 10, wherein the determining whether the second origination IP is the proxy is based on comparing the stored domain name information and a file name information with the second domain name information and a second file name information.

13. The non-transitory computer-readable medium of claim 8, wherein the determining whether the second origination IP is the proxy is based on a geographical distance between a first geographical location of the first origination IP address and a second geographical location of the second origination IP address.

14. The non-transitory computer-readable medium of claim 8, wherein the determining whether the second origination IP is the proxy is based on a first country of the first origination IP address and a second country of the second origination IP address.

15. The non-transitory computer-readable medium of claim 8, wherein the script file is configured to cause the client to issue a request for a unit of content specified by the domain name information and a file name information.

16. A computerized system for detecting a proxy, the system comprising:
a. a database system;
b. a web server for:
receiving a request from a client; and
responsive to the received request, generating a file containing a domain name information and a file name information and storing the domain name information and the file name information in the database system and returning the generated script file to the client;
c. a domain name server (DNS) for:
receiving a DNS request on the DNS server, the DNS request specifying a domain name information for a domain name to be resolved; and
responsive to the received DNS request, storing a first origination IP address associated with received DNS request and the domain name information in the database system,
wherein:
the web server receives a second request from a client, the second request specifying a file name information specified in the first response of the web server;
responsive to the received second request, the web server stores a second origination IP address associated with the received second request and the second file name information in the database system; and
the proxy is detected based on information stored in the database system.

17. The computerized system of claim 15, wherein the script file is a Java script file.

18. The computerized system of claim 15, wherein the domain name information and the file name information are both randomly generated.

19. The computerized system of claim 17, wherein the detection of the proxy is based on comparing the stored domain name information and a file name information with the second domain name information and a second file name information.

20. The computerized system of claim 15, wherein the detection of the proxy is based on a geographical distance between a first geographical location of the first origination IP address and a second geographical location of the second origination IP address.

21. The computerized system of claim 15, wherein the detection of the proxy is based on a first country of the first origination IP address and a second country of the second origination IP address.

22. The computerized system of claim 15, wherein the script file is configured to cause the client to issue a request for a unit of content specified by the domain name information and a file name information.
